(19) United States
(12) Patent Application Publication
(10) Pub. No.: US 2001/0007163 A1
(43) Pub. Date: Jul. 12, 2001

(54) Damper assembly that opts to open doors for usage with reciprocating door closer devices

(76) Inventor: Ricardo Alonso, Denver, CO (US)

Correspondence Address: Alonso, Ricardo, 111 S. Perry St., Denver, CO, 80219, US

(21) Appl. No.: 09/731,947

(22) Filed: Dec. 6, 2000

Related U.S. Application Data
(63) Continuation-in-part of application No. 09/473,822, filed on Dec. 28, 1999.

(51) Int. Cl. E05F 3/10

(52) U.S. Cl. 16/58; 16/49

(57) ABSTRACT

A damper assembly (50) adapted to a reciprocative door closer device (10) and contingent door (62), the device (10) comprising a piston rod (16) which functions reciprocatively from within a piston body (12) controlling a biasing means (11); the rod (16) normally loosely mounted with a checking mechanism (22) for variably holding both the rod (16) in an extended position (16-B) and a door (62) in an open position (62-B); the assembly (50) comprising a fixated bracket (50-A) with an offsetting fastener means (52) for universal attachment to left and right hinging doors (62), and, similar to the reciprocative device (10), the assembly (50) comprising an extensible bracket (50-A) controlling a counter biasing means (55) by use of an operator (54) selected from a group including a spring operator means (54-A) that acts to dampen, counter, and protect the device (10) and the door (62) from damage due to excessive inward biasing forces (11-B), and, acts to compensate for a superior checking mechanism (22) such as when the extended rod (16-B) is being held with the engaged mechanism (22-B) and the opened door (62-B) is moved towards the closed position (62-A) without first disengaging the mechanism (22-B), which, simultaneously now commissions the device (10) to return the door (62) to the exact opened position (62-B) determined by the engaged mechanism (22-B) holding the extended rod 16-B.

This is a continuation-in-part of Ser. No. 09/473,822 filed on Dec. 28, 2000.

### TECHNICAL FIELD

This invention relates to various reciprocative devices comprising a rod that functions from within a body controlling a biasing means. A reciprocating door closer installed on a contingent screen or storm door exemplifies such a device. To close the door, the rod reciprocates responsive to the biasing means controlled by the device. The rod is normally loosely mounted with a checking mechanism for holding the door in an opened position. Utilizing the biasing means, the mechanism simultaneously engages the closer rod and the body to transpose the biasing means into friction pressure applied to the surface of the rod. Resultantly, the door is held in an opened position by the checking mechanism. More particularly, this invention relates to an improved apparatus and methodology to dampen, counter, and protect the device and the contingent door from damage due to excessive inward biasing forces, and to compensate for a superior checking mechanism which can now be commissioned to variably open the door. The invention may be incorporated with U.S. Pat. Nos. 5,829,098; 5,953,789, and 6,032,331 all to Alonso, for creating a preferred door operator device.

### BACKGROUND ART

A portion of the disclosure of this patent document contains material which is subject to copyright protection. The copyright owner has no obligation to the facsimile reproduction by anyone of the patent document or the patent disclosure, as it appears in the Patent And Trademark Office patent file or records, but otherwise reserves all copyright whatsoever.

A brief description of a reciprocative device includes a basic door closure device which is controlled in part with fluid, either hydraulic or pneumatic. The device may typically comprise a piston assembly including a piston and sealing o-ring; piston rod varieties which include curved and non-curved surfaces; internal compression spring operators and fluid biasing operators; cylindrical piston body; sealed and non-sealed end caps and grommets; fluid restriction valves; attachment members; and the checking mechanism which holds the door opened. Such door closer devices are described in U.S. Pat. Nos. 2,732,920; 2,920,338; 3,032,806; 3,162,889; 3,566,435; 3,665,549; 4,777,698; and Can. Pat. No. 623,038. A superior checking mechanism is extensively described in U.S. Pat. Nos. 5,953,789 and 6,032,331.

The hold-open feature is manually activated by first opening the door to a desired position, thus creating an outward biasing force that extends the piston rod from within the piston body. A biasing inward force is then reciprocatively created and controlled by the internal biasing operator. Releasing the door, the internal operator acts to return the rod towards the normally retracted position within the body. The checking mechanism, also known as a hold-open tab, is axially mounted onto the rod through an aperture. Once the piston body contacts the mechanism, the biasing force causes the mechanism to lever. A direct frictional pressure is torsionally created by opposing points comprised within the aperture, applied onto surfaces of the piston rod whereby the mechanism frictionally checks the device to hold the door opened. More biasing force controlled by the internal operator results in more direct pressure causing the friction onto the surfaces of the rod. As with all prior art reciprocative devices utilizing checking mechanisms, before closing the door the mechanism must be disengaged in order to return the extended rod back into the closer body. Note that U.S. Pat. No. 2,732,920 describes a cog method of checking the rod however functions similar to other prior art devices.

The art has never before revealed any substantial reason to dampen the device to protect from damage due to excessive inward biasing forces, nor to compensate for a superior checking mechanism. When a door is being held opened with any checking mechanism, excessive inward biasing forces can be caused by an unsuspecting person that attempts to close the door without first releasing the mechanism. Not knowing that the door is actually being held opened by the mechanism, tremendous leverage may be generated by pushing on the outermost edge of the door. The person's psychological then physical reaction may be to push harder in an effort to close the door. Most prior art mechanisms are manufactured from common sheet steel which is relatively soft, and can fail when placed under similar excessive inward biasing forces.

However, a superior mechanism that is substantially tempered and hardened may increase the life of the door closer device, but unfortunately will not reveal any give to compensate for the excessive inward biasing force. Substantial damage to various components may include the contingent door and door frame, and the door closer device. If the device is not equipped with a clip plate to accommodate the doorjamb bracket, the bracket may be forcibly detached from atop the doorjamb. Because the device is typically fastened to the door with sheet metal screws that do not penetrate the entire substance of door, such as with a bolt and threaded fastener nut, the device may then be forcibly detached from atop the door. These and other issuers create a shortened life span for the device, which coincidentally offers the industry certain obsolescence resulting in frequent consumer purchases. The reader will also realize that the invention may be adapted onto any device including those not equipped with a superior checking mechanism.

Another issue of concern defines the need for better convenience when utilizing the checking mechanism to hold the door opened for certain passage through the doorway. When people using mobility products such as wheelchairs and walkers encounter a door having a door closer device, often the device alone poses an extreme inconvenience. First, the user can not easily access the checking mechanism to hold the door opened especially if the device is located at the top of the door. Second, not only is it difficult to position the mobility product to engage the mechanism, it then becomes difficult or impossible to disengage it to close the door especially once the user is positioned on the door side opposite from the closer. Without the use of a hold-open tab to pass through the doorway, the user is not only burdened to fully open the door for accommodating the chair or walker, but must also try to push the door while negotiating through the doorway.

FIG. 10 illustrates a prior art door closer device (10) not to be confuse as anticipating the inventive concepts submitted herein. The coil spring assembly (50) is adapted to function with the rod (16) and the doorjamb bracket (61), for only protecting the device (10) and contingent door (not shown) from an excessive outward biasing forces (11-A) particularly from a sudden wind gust. As the rod (16) is maximally extended from the body (12), the coil spring assembly (50) dampens by providing a minimal reciprocative movement. Known with absolute certainty, this assembly does dampen, counter, protect, nor compensate the device and the contingent door from damage due to any excessive inward biasing forces. It is unclear as to why the art would offer such this assembly on the exterior piston rod of the device, as a similar assembly has long been implemented on the interior of the piston body. Perhaps the art is seeking a marketing method to initiate consumer purchasing interests. I believe that this exterior assembly merely complicates the device and does not offer any substantial benefit over the previous interior assembly. Replacement options for the checking mechanism are also substantially eliminated. Respectfully, none of the disclosures of this prior art assembly are anticipated, required, initiated, nor beneficial towards the superior inventions disclosed herein.

### DISCLOSURE OF THE INVENTION

The present invention comprises a damper assembly adapted to and between a reciprocative door closer device and contingent door. An object of these inventions are dampen, counter, and protect the device and the contingent door from damage due to excessive inward biasing forces. Another object of these inventions are to compensate the device for a superior checking mechanism. Another object of these inventions are to provide better convenience when utilizing a checking mechanism to hold the door opened for passage through the doorway, especially for people using mobility products such as wheelchairs and walkers. Another object of these inventions are to optionally convert the door closer device into a door operator capable of opening a door to various positions determined by the location of the hold-open tab engaging the rod. Another object of these inventions are to create an inexpensive door operator device without substantially impeding the normal closing function of the door closer device. Another object of these inventions are to permit the door to be closed when the rod is held in an extended position with a checking mechanism mounted onto the device. Another object of these inventions are to activate an automatic door open feature by simply unlatching the door from a closed position. Another object of these inventions are to variably regulate the distance that the door will automatically open, determined and coinciding with the position of the checking mechanism engaged on the rod. Another object of these inventions are to close the door with a gentle nudge. Another object of these inventions are to permit the door to be closed smoothly without any bouncing, unlike the closing action of prior art door closers not equipped with these inventions.

The damper assembly may comprise a fixated bracket comprising an offsetting fastener means. An object of these inventions are to permit universalness for a singular assembly that is adaptable to left and right hinging doors. Another object of these inventions are to improve the fastener screws for the fixated bracket. The fixated bracket may house an extensible bracket also controlling a separate counter biasing means by usage of an operator, similar the reciprocative device adapted thereto. The extensible bracket may be further urged by the operator to control a counter outward biasing force acting to accommodate the extended rod of the device, and a counter inward biasing force acting to return the device to a normal position. An object of these inventions are to return the device and contingent door to a normal position determined by the checking mechanism engaging the rod, thus causing the device to open and hold the door responsive to the position of the mechanism. Another object of these inventions are to move the door to a fully closed position while the checking mechanism remains engaged on the extended rod of the device. Another object of these inventions are to alleviates the need to return the checking mechanism to an idle position on the rod before returning the door to the closed position. Another object of these inventions are to accommodate the length of extended rod by compensating the device. Another object of these inventions are to create a door operator that offers a consistent and gentle operating pressure to move the door. Another object of these inventions are to create a no-pinching design offers minimal liability and does not permit children to pinch fingers that are accidentally placed inside the assembly. Another object of these inventions are to shorten the time required for the door to move to the closed position from any normally opened position. Another object of these inventions are to close an unattended door being held opened by a checking mechanism during sudden wind gust conditions and if the wind is sufficient to create momentum for the door.

The counter biasing means may be controlled by various operators selected from the group consisting of a spring operator means, a fluid operator means, and cog operator means. Another object of these inventions are to permit selection from various improved apparatus and methodologies to dampen, counter, protect, and compensate the device and the contingent door from damage due to excessive inward biasing forces, without straying from the inventive concepts disclosed herein.

The assembly can be bypassed and easily locked off by using a simple lock means to block the action of the extensible bracket. An object of these inventions are to allow the device to function similarly to a prior art device. The members and other components may be substantially tempered and hardened. An object of these inventions are to provide long life for the door closer device. Another object of these inventions are to provide maximum strength for the device.

These and further objects and advantages of the invention will be apparent from the following description of the preferred embodiments thereof.

### BRIEF DESCRIPTION OF THE DRAWINGS

FIG. 1 is a prospective view of a superior reciprocative door closer device comprising a superior checking mechanism. The invention, a damper assembly is conceptually positioned to mount onto the device. A cutout on the assembly illustrates a spring operator.

FIG. 2 is a prospective view of the device of FIG. 1, now mounted with the damper assembly shown in a normally retracted position.

FIG. 3 is a prospective view of the device of FIG. 2, the device now engaged with the checking mechanism holding the rod in an extended position, the damper assembly compensating the device from the extended rod and the inward biasing forces.

FIG. 4 is a top view of a reciprocative door closer device and damper assembly adapted to and mounted between the device and contingent door. The device and contingent door are shown in three positions: a closed position; an opened position; and a dampened position.

FIG. 5 is a top view of a reciprocative door closer device and damper assembly adapted to and mounted between the device and contingent door shown in three positions: a closed position; an opened position; and a dampened position. The assembly is now set to optionally open the door from the closed position.

FIG. 6 is a prospective view of a superior reciprocative door closer device and the invention, a conceptual damper assembly and biasing means operator comprising a fluid means.

FIG. 7 is a prospective view of a superior reciprocative door closer device and the invention, a conceptual damper assembly and biasing means operator comprising a cog means.

FIG. 8 is a prospective view of a superior reciprocative door closer device conceptually controlling in reversal, now mounted with damper assembly adapted on the same end of the piston rod designed to adapt a contingent door.

FIG. 9 is a reference list.

PRIOR ART

FIG. 10 is a prior art door closer device providing a damper assembly adapted on the exterior piston rod, limited only to protect from excessive outward biasing forces.

### BEST MODES FOR CARRYING OUT THE INVENTION

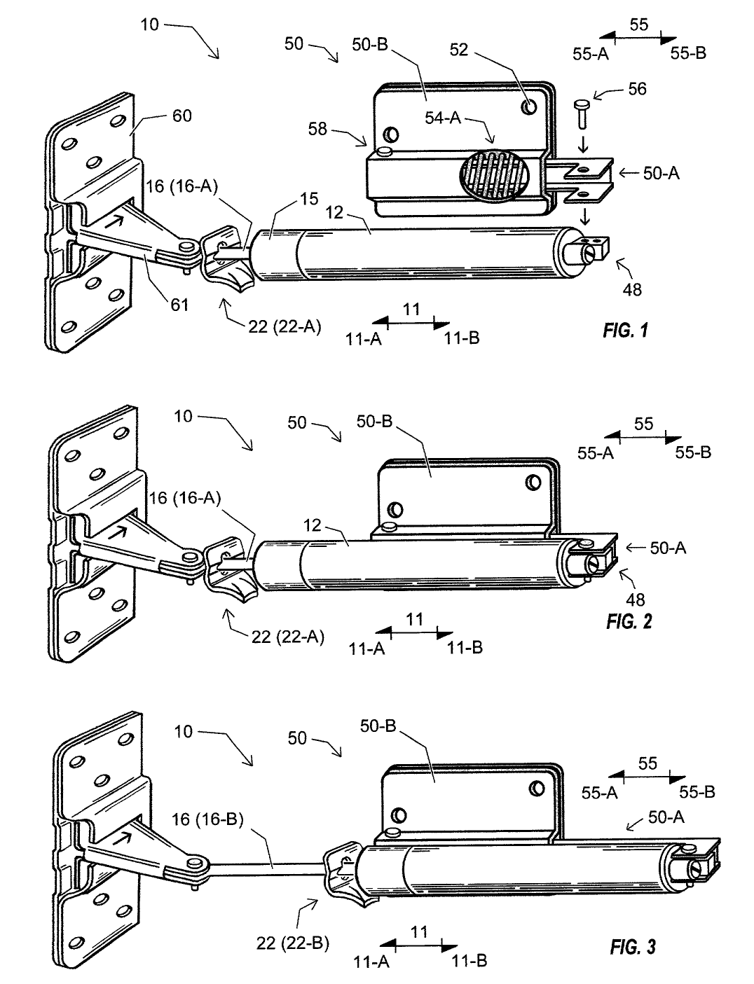

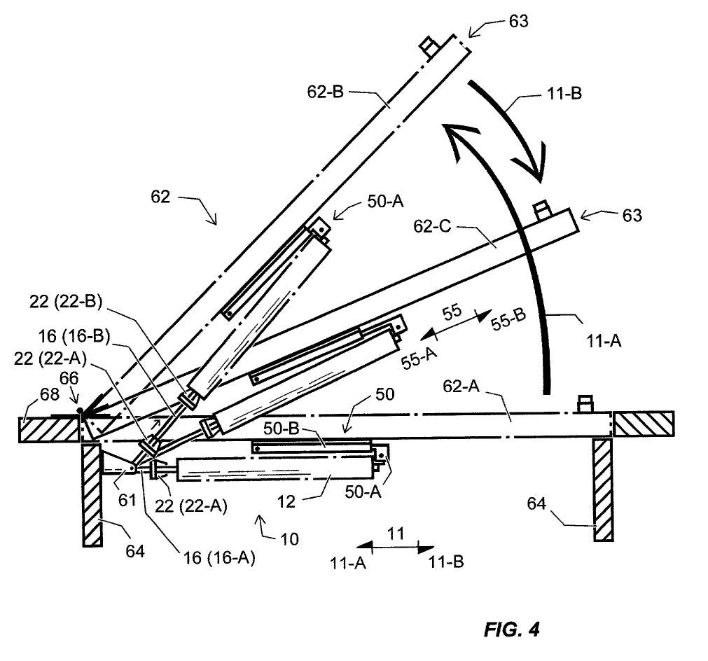

FIGS. 1-5 are taught conceptually together wherein FIG. 1 is a prospective view of a superior door closer device 10 comprising a piston rod 16 functions from within a piston body 12 controlling a biasing means 11. A superior, substantially tempered and hardened checking mechanism 22 shown in an idle position 22-A is mounted onto the piston rod 16 shown in the retracted position 16-A. A clip plate 60 is accommodating the doorjamb bracket 61 which normally mounts atop a doorjamb (not shown). The invention, a damper assembly 50 is positioned to mount onto the device 10 at the lug mount 48 using a lug pin 56 or similar fastener. The assembly 50 comprises a fixated bracket 50-B providing offsetting fasteners holes 52 for universal left and right attachment to a contingent door 62, shown in FIG. 4, and an extensible bracket 50-A which attaches to the mount 48 of the body 12. A cutout window illustrates that the extensible bracket 50-A is controlled by a spring operator 54-A capable of providing a counter biasing means 55.

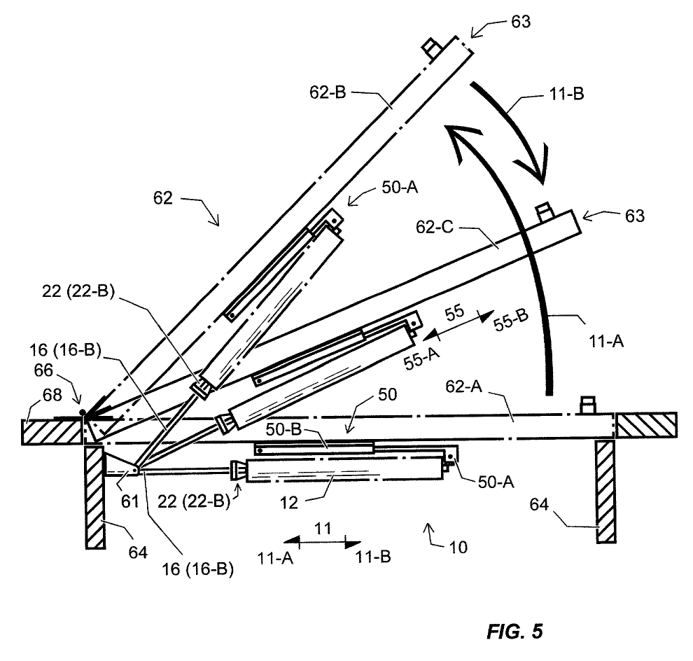

FIG. 2 illustrates the damper assembly 50 now mounted onto the device 10, and shown in a normally retracted position comparable to the device 10 from the door closed position 62-A of FIG. 4. FIG. 3 illustrates that the rod 16 is in an extended position 16-B, held with the superior checking mechanism 22 in the engaged position 22-B, comparable to the door dampened position 62-C of FIG. 4, and comparable to the door closed position 62-A of FIG. 5. Conceptually, an outward biasing force 11-A has urged the rod 16 into an extended position 16-B, and the checking mechanism 22 has been moved into an engaged position 22-B. Thus, the inward biasing force 11-B is also checked by the engaged mechanism 22-B, and the extensible bracket 50-A is responsively providing a counter outward biasing force 55-B.

FIG. 4 are taught conceptually together wherein FIG. 3 is top view of a door closer device 10 and contingent door 62 shown in three positions: a closed position 62-A; an opened position 62-B; and a dampened position 62-C. The device 10 functions as the biasing means 11 extends the rod 16 away from the body 12 with outward force 11-A, such as when a person moves the door 62 from the closed position 62-A towards the opened position 62-B. The inward force 11-B controlled by the device 10 urges the rod 16 into the body 12. The checking mechanism 22 is holding the door 62 in the opened position 62-B, by engaging the rod 16 and contacting the body 12. The assembly 50 is attached onto the device 10 on the opposite end of the rod 16 to opt for removal and replacement of the mechanism 22.

FIG. 4 illustrates that The assembly 50 is adapted to and mounted between the device 10 and contingent door 62, although it can be optionally mounted to either the closer body 12 or the piston rod 16. As the door 62 is moved from the opened position 62-B towards the closed position 62-A such as when an unsuspecting person pushes on the door 62, the spring operator 54-A controlling the extensible bracket 50-A provides a counter outward force 55-B permitting the door to moved into the dampened position 62-C. Resultantly, the assembly 50 dampens, counters, protects, and compensate the device 10 and contingent door 62 from damage due to the excessive inward biasing force 11-B that could normally result if the device 10 and door 62 were not mounted with the assembly 50. The reader can easily imaging the excessive amount of leverage that can be generated by pushing on the outermost edge 63 of the door 62. Damaging results to the door closer device 10 may include the piston rod 16, the checking mechanism 22, and the doorjamb bracket 64. Other damage that may occur to the door 62 included the door hinge 66 and the door frame 68. The extensible bracket 50-A may be capable of an abrupt counter biasing movement 55. This action may detour the person's psychological then physical reaction to push harder in an effort to move the door 62 from the opened position 62-B towards the closed position 62-A.

FIG. 5 is a top view of a door closer device 10 and contingent door 62 also shown in three positions: a closed position 62-A; an opened position 62-B; and a dampened position 62-C, illustrating that the door 62 may now be moved to a fully closed position 62-A without first returning the checking mechanism 22 to an idle position 22-A. This is now possible because the extended rod 16 is physically compensated by the extensible bracket 50-A controlled by the counter biasing means 55. The extensible bracket 50-A urged by the spring operator 54-A that controls the counter inward biasing force 55-A, acts to return the door 62 to the normally opened position 62-B determined by the engaged checking mechanism 22-A holding the extended rod 16-B. Resultantly, the assembly 50 creates an inexpensive door operator device 10 that comprises a unique door open and hold capability without substantially impeding the normal closing function of the device 10.

To reactivate the door 62 to any opened position 62-B, the door 62 must simply be unlatch from the closed position 62-A. The distance that the door 62 can be opened by the device 10 is easily variable, coinciding with the position of the engaged mechanism 22-A on the extended rod 16-B, up to the point where the extensible bracket 50-A is maximally extended when the door 62 is moved to the closed position 62-A. Because of the reliability of the superior hold-open tab 22, which through natural gravity always remains poised for engagement onto the extended rod 16-B, a unique memory is created to re-open the door 62 to the previous opened position 62-B determined by the engaged checking mechanism 22-A. By simply increasing the length of the extensible bracket 50-A, the assembly 50 can be designed to open and hold any door 62 to a fully opened position 62-B, a useful feature for people using mobility products such as wheelchair and walker users.

Under normal usage, the door 62 can be returned to the closed position 62-A with a gentle nudge. This is possible due to the hanging weight and momentum of the door 62 which participates in the normal closing action. When closing the door 62, the assembly 50 reduces most bouncing for the door closer 10 unlike the closing action of a prior art device 10 without the assembly 50. Due to the pressure created by the counter outward force 55-B, the door 62 moves effortless because biasing forces 11 of the device 10 are substantially equalized by the biasing forces 55 of the assembly 50. The result is smoother closing for the door 62 from any average door opened position 62-B, and normal closing action from any partial dampened position 62-C. This feature will be most desired by elderly residents and young children who may not have sufficient physical strength to move heavier doors 62. Additionally, during sudden wind gust conditions the assembly 50 can actually permit an unattended door 62 being held in an opened position 62-B to swing to a fully closed position 62-A.

The physical characteristics of the simplistic extensible bracket 50-A controlled by the spring operator 54-A defines reliability for the assembly 50, while offering a consistent and gentle pressure to move the door 62, measured at less than 1 pound of torque at the outer edge of the door 62. A no-pinching design offers minimal liability, not permitting children to pinch fingers that are accidentally placed inside the assembly 50. The assembly 50 can be bypassed and easily locked off by using a simple lock means 58 to block the action of the extensible bracket 50-A. This feature will allow the device 10 to function as a prior art device 10. Also, the time required for the door 62 to move to the closed position 62-A has been substantially reduced which resolves the need to hurriedly force the door 62 to the closed position 62-A for locking purposes. This feature may further extend the life of the door closer device 16. The components of the assembly 50 including the brackets 50-APB, and the operators 54-A,B,C, may be substantially tempered and hardened to provide long life for the device 10.

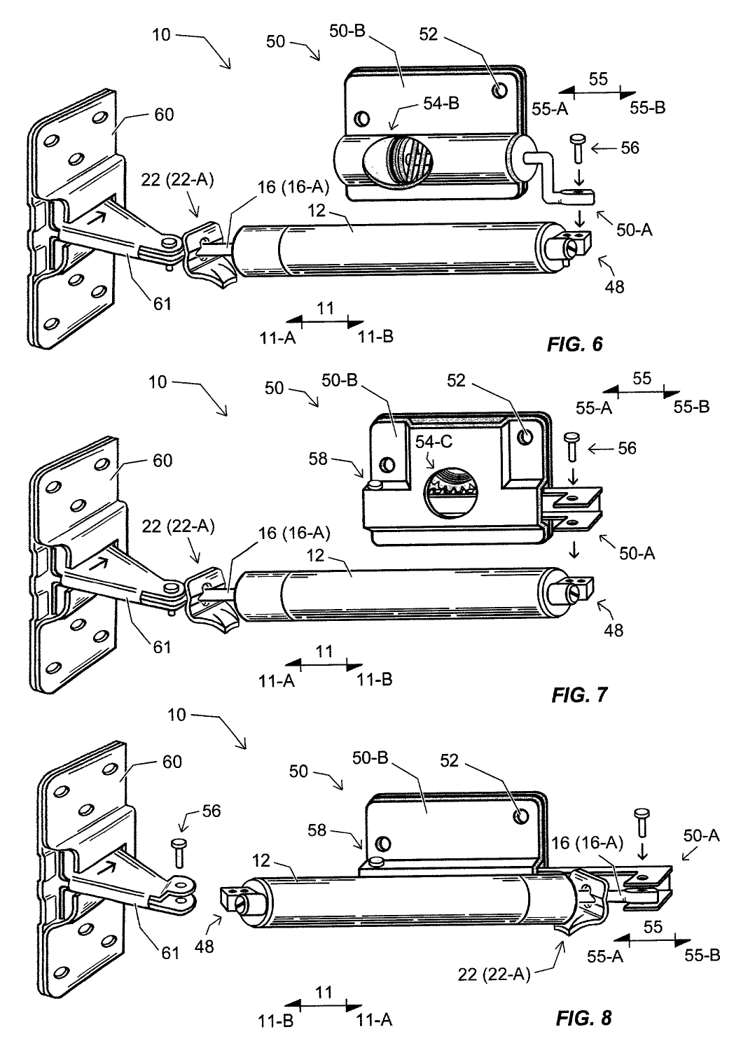

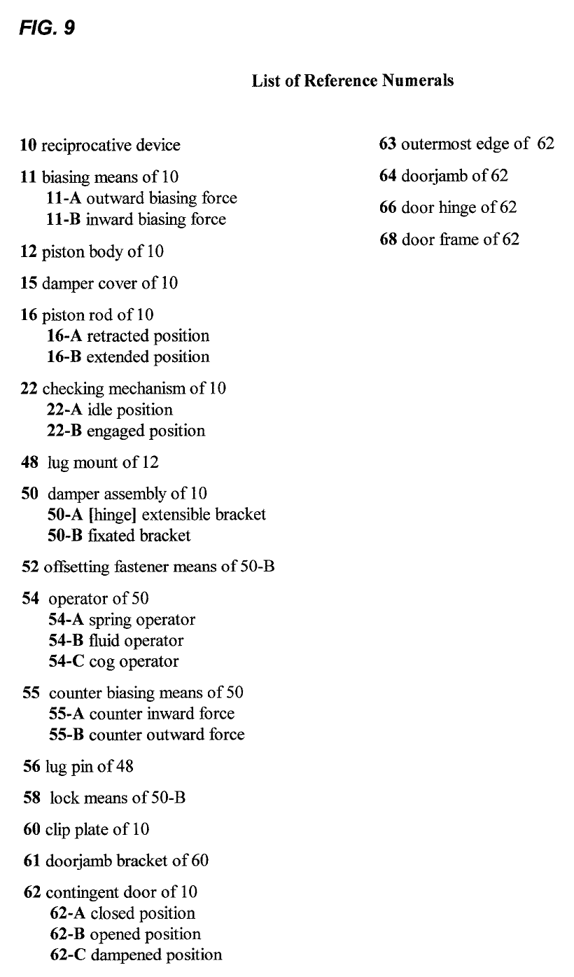

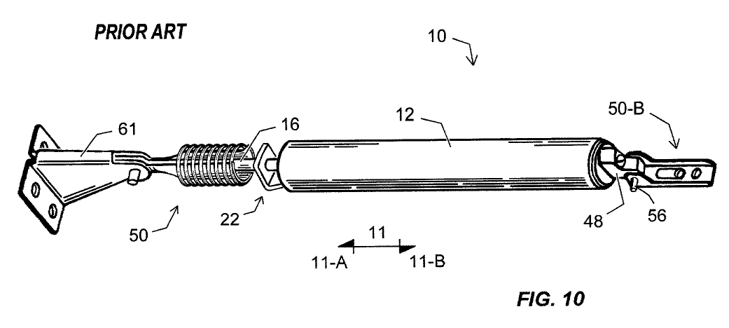

FIG. 6 is a prospective view of a superior reciprocative door closer device 10 equipped with a conceptual counter damper assembly 50 comprising a fluid operator means 54-B. FIG. 7 is a prospective view of a superior device 10 equipped with a conceptual damper assembly 50 comprising a cog operator means 54-C. These assemblies 50-B,C comprises a fixated bracket 50-B housing an extensible bracket 50-A controlled by their respective operators 54-B,C, both capable of providing a counter biasing means 55. Perhaps these assemblies 50-B,C could also offer adjustability such as a valve for the fluid operator 54-B and a winding spring means for the cog operator 54-C. Note that any element of the assembly 50 comprising the spring operator 54-A may be used in conjunction with theses assemblies 50-B,C.

FIG. 8 is a prospective view of a superior reciprocative door closer device 10 conceptually controlling a biasing means 11, now illustrated with the damper assembly 50 poised to be adapted the piston rod 16 and contingent door 62. Although the superior checking mechanism 22 should never require replacement, the lug pin 56 permits it's optional removal. Note that the biasing means 11 for the device 10 are referenced in reversal. As the inward biasing force 11-B may be checked with the mechanism 22, the extensible bracket 50-A may responsively provide a counter outward biasing force 55-B to dampen, counter, protect, and compensate the device 10 and the contingent door 62 from any damage due to the excessive inward biasing forces 11-B.

### INDUSTRIAL APPLICABILITY

The present invention comprises a damper assembly adapted to and between a reciprocative door closer device and contingent door to dampen, counter, protect, and compensate the device and the door from damage due to excessive inward biasing forces, such as when the rod of the device is being held in an extended position with a superior checking mechanism and an unsuspecting person urges the door from an opened position towards the closed position. Resultantly, the assembly creates an inexpensive door operator device that comprises a unique door open and hold capability that is much needed for disabled and elderly people using mobility products such as wheelchairs and walkers. With certain devices, the assembly may be incorporated on the piston rod and/or the traditional method of mounting the door closer device may require that the rod mount onto the door. The invention may be installed onto various other reciprocative devices that do not comprise superior nor traditional checking mechanisms, as these devices may now comprise a limited life which could be extended by the invention. Other benefactor devices may include automotive lift supports, cabinetry and other similar door types. The invention may also be possibly incorporated on the exterior side of the door, possibly functioning with or without a traditional prior art door closer device. When combining these inventions with other related inventions, a superior reciprocative door operator device is created.

The particular embodiments of the present invention which have been illustrated and discussed herein are for illustrative purposes only and are not considered as a limitation upon the scope of the appended claims. In these claims set forth it is my intent to claim the entire invention disclosed herein, except as I am limited by the prior art.

Accordingly, the scope of the invention should not be determined only by the embodiments illustrated, but also by the appended claims and their legal equivalents. From the above description of the invention submitted, various changes and modifications and improvements may occur to the apparatus. All such claims are intended to be included therein.

I claim:

18. A method of commissioning a door (62) to move from a closed position (62-A) to any normally opened position (62-B), contingent to a reciprocative door closer device (10) that includes a piston rod (16) loosely mounted with a checking mechanism (22) for variably holding both the rod (16) in any extended position (16-B) and the door (62) in the open position (62-B); said rod functioning reciprocatively from within a piston body (12) controlling a biasing means (11), that, upon an applying an outward biasing force (11-A) causing said rod (16) to move from a normally retracted position (16-A) towards any extended position (16-B) reactive to the movement of said door (62) towards the opened position (62-B), said device (10) normally acting to control a reciprocative inward biasing force (11-B) for again returning said door (62) towards the closed position (62-A) responsively; said method comprising the steps of
engaging the checking mechanism (22-B) to hold the rod (16) in any extended position (16-B) coinciding with the door (62) also being held in an open position (62-B);
creating an inward biasing force (11-B) causing said door (62) to move from said opened position (62-B) to a fully closed position (62-A), while the mechanism (22-B) remains engaged on the extended rod (16-B);
preventing said rod (16) to move towards the normally retracted position (16-A) controlled by said inward biasing force (11-B), now providing excessive inward biasing forces (11-B) reactive to said mechanism (22-B) remaining engaged on said extended rod (16-B);
countering said excessive inward biasing force (11-B) and compensating the extended rod (16-B) by use of a damper assembly (50) adaptable onto said device (10) and contingent door (62), comprising a fixated bracket (50-B) housing an extensible bracket (50-A) controlling a counter outward biasing means (55-B) by use of an operator (54);
urging said door (62) from said closed position (62-A) to return to the previously opened position (62-B) determined by the engaged checking mechanism (22-B) mounted on the extended rod (16-B);
whereby the damper assembly (50) dampens, counters, protects, and compensates the door closer device (10) and contingent door (62) from any damage due to the excessive inward biasing force (11-B) that would naturally occur if not commissioned by said assembly (50).

19. A damper assembly (50) adapted to a reciprocative device (10) and contingent object (62) such as a door closer device (10) and contingent door (62), said device (10) including a piston rod (16) loosely mounted with a checking mechanism (22) for variably holding both the rod (16) in an extended position (16-B) and a door (62) in an open position (62-B); said rod (16) functioning reciprocatively from within a piston body (12) controlling a biasing means (11), that, upon an applying an outward biasing force (11-A) causing said rod (16) to move from a retracted position (16-A) towards any extended position (16-B) from within the body (12), said device (10) normally acting to control a reciprocative inward biasing force (11-B) responsively; comprising
a fixated bracket (50-B) housing an extensible bracket (50-A) controlling a counter biasing means (55) by use of an operator (54) adaptable to said device (10) and contingent door (62);
whereby the damper assembly (50) dampens, counters, protects, and compensates the door closer device (10) and contingent door (62) from damage due to excessive inward biasing force (11-B).

20. The damper assembly (50) adapted to a reciprocative device (10) and contingent object (62) such as the door closer (10) and door (62) of claim 19, wherein
said operator (54) is selected from the group of a spring operator means (54-A), a fluid operator means (54-B), and a cog operator means (54-C).

21. The damper assembly (50) adapted to a reciprocative device (10) and contingent object (62) such as the door closer (10) and door (62) of claim 19, wherein
said extensible bracket (50-A) may be further urged by said operator (54-A,B,C) to control a counter outward biasing force (55-B), acting to accommodate the extended rod (16-B).

22. The damper assembly (50) adapted to a reciprocative device (10) and contingent object (62) such as the door closer (10) and door (62) of claim 21, wherein
said counter outward biasing force (55-B) further acting to return the door (62) to the normally closed position (62-A), responsive to said device (10) mounted with a checking mechanism (22) means that may be engaging the extended rod (16-B).

23. The damper assembly (50) adapted to a reciprocative device (10) and contingent object (62) such as the door closer (10) and door (62) of claim 19, wherein
said extensible bracket (50-A) may be further urged by said operator (54-A,B,C) to control a counter inward biasing force (55-A) acting to return the device (10) and contingent door (62) to a normal position.

24. The damper assembly (50) adapted to a reciprocative device (10) and contingent object (62) such as the door closer (10) and door (62) of claim 23, wherein
said counter inward biasing force (55-A) further acting to return the door (62) to any normally opened position (62-B), responsive to said device (10) mounted with a checking mechanism (22) means that may be engaging the extended rod (16-B).

25. The damper assembly (50) adapted to a reciprocative device (10) and contingent object (62) such as the door closer (10) and door (62) of claim 19, wherein
said fixated bracket (50-B) further provide a lock means (58) to cancel said counter biasing means (55) controlled by said operator (54).

26. The damper assembly (50) adapted to a reciprocative device (10) and contingent object (62) such as the door closer (10) and door (62) of claim 25, wherein
said fixated bracket (54-B) comprising an offsetting fastener means (52) permitting universalness for a singular assembly (50) adaptable to left and right hinging doors (62).

27. A method of dampening a reciprocative device (10) and contingent object (62) such as a door closer (10) and door (62), said device (10) including a piston rod (16) which functions reciprocatively from within a piston body (12) having a biasing means (11), that, upon the extension of the rod (16-B) from within the body (12), said device (10) normally acting to control the reciprocation of said rod (16); comprising the steps of
applying an outward biasing force (11-A) to cause the rod (16) to be at least partially extended from within the body (12), thereby creating a reciprocative inward force (11B) responsive to said device (10);
resisting the inward biasing force (11-B) and the extended rod (16-B) from within the body (12), normally acting to return the device (10) and contingent door (62) to a closed position (62-A);
accommodating said extended rod (16-B) by use of a damper assembly (50) adapted to and between said device (10) and contingent door (62), comprising a fixated bracket (50-B) housing an extensible bracket (50-A) controlling a counter biasing means (55) by use of an operator (54);
whereby the damper assembly (50) dampens, counters, protects, and compensates the door closer device (10) and contingent door (62) from damage due to excessive inward biasing force (11-B).

28. The method of dampening a reciprocative device (10) and contingent object (62) such as the door closer (10) and door (62) of claim 27, wherein
said operator (54) is selected from the group of a spring operator means (54-A), a fluid operator means (54-B), and a cog operator means (54-C).

29. The method of dampening a reciprocative device (10) and contingent object (62) such as the door closer (10) and door (62) of claim 27, wherein
said counter outward biasing force (55-B) further acting to return the door (62) to the normally closed position (62-A), responsive to said device (10) mounted with a checking mechanism (22) means that may be engaging the extended rod (16-B).

30. The method of dampening a reciprocative device (10) and contingent object (62) such as the door closer (10) and door (62) of claim 27, wherein
said extensible bracket (50-A) may be further urged by said operator (54-A,B,C) to control a counter inward biasing force (55-A) acting to return the device (10) and contingent door (62) to a normal position.

31. The method of dampening a reciprocative device (10) and contingent object (62) such as the door closer (10) and door (62) of claim 30, wherein
said counter inward biasing force (55-A) further acting to return the contingent door (62) to any normally opened position (62-B) responsive to the device (10) mounted with a checking mechanism (22) means that may be engaging the extended rod (16-B).

32. The method of dampening a reciprocative device (10) and contingent object (62) such as the door closer (10) and door (62) of claim 27, wherein
said fixated bracket (50-B) further provide a lock means (58) to cancel said counter biasing means (55) controlled by said operator (54).

33. The method of dampening a reciprocative device (10) and contingent object (62) such as the door closer (10) and door (62) of claim 32, wherein
said fixated bracket (54-B) comprising an offsetting fastener means (52) permitting universalness for a singular assembly (50) adaptable to left and right hinging doors (62).

34. An improved a reciprocative device (10) attached to a contingent object (62) such as a door closer (10) attached to and door (62), said device (10) including a piston rod (16) loosely mounted with a checking mechanism (22) for variably holding both the rod (16) in any extended position (16-B) and the door (62) in the open position (62-B); said rod functioning reciprocatively from within a piston body (12) having a biasing means (11), that, upon an applying an outward biasing force (11-A) causing extension of the rod (16-B) from within the body (12), said device (10) normally acting to control a reciprocative inward biasing force (11-B) responsively; said device (10) including a damper assembly (50) to dampen, counter, protect, and compensate said device (10) and contingent door (62) from damage due to excessive inward biasing forces (11-B), comprising
a substantially tempered and hardened checking mechanism (22;
a fixated bracket (50-B) housing an extensible bracket (50-A) controlling a counter biasing means (55) by use of an operator (54) adaptable to and between said device (10) and contingent door (62);
whereby said device (10) can now be commissioned to return the door (62) to the exact opened position (62-B) determined by the mechanism (22) in any engaged position (22-B) holding the extended rod 16-B.

35. The improved reciprocative device (10) attached to a contingent object (62) such as the door closer (10) attached to the door (62) of claim 34, further comprising
said operator (54) is selected from the group of a spring operator means (54-A), a fluid operator means (54-B), and a cog operator means (54-C).

36. The improved reciprocative device (10) attached to a contingent object (62) such as the door closer (10) attached to the door (62) of claim 34, further comprising
said extensible bracket (50-A) may be further urged by said operator (54-A,B,C) to control a counter outward biasing force (55-B), acting to accommodate the extended rod 16.

37. The improved reciprocative device (10) attached to a contingent object (62) such as the door closer (10) attached to the door (62) of claim 36, further comprising
said counter outward biasing force (55-B) further acting to return the door (62) to the normally closed position (62-A), responsive to said device (10) mounted with a checking mechanism (22) means that may be engaging the extended rod (16-B).

38. The improved reciprocative device (10) attached to a contingent object (62) such as the door closer (10) attached to the door (62) of claim 34, further comprising
said extensible bracket (50-A) may be further urged by said operator (54-A,B,C) to control a counter inward biasing force (55-A) acting to return the device (10) and contingent door (62) to a normal position.

39. The improved reciprocative device (10) attached to a contingent object (62) such as the door closer (10) attached to the door (62) of claim 38, further comprising
said counter inward biasing force (55-A) further acting to return the contingent door (62) to any normally opened position (62-B) responsive to the device (10) mounted with a checking mechanism (22) means that may be engaging the extended rod (16-B).

40. The improved reciprocative device (10) attached to a contingent object (62) such as the door closer (10) attached to the door (62) of claim 34, further comprising
said fixated bracket (50-B) further provide a lock means (58) to cancel said counter biasing means (55) controlled by said operator (54).

41. The improved reciprocative device (10) attached to a contingent object (62) such as the door closer (10) attached to the door (62) of claim 40, further comprising
said fixated bracket (54-B) comprising an offsetting fastener means (52) permitting universalness for a singular assembly (50) adaptable to left and right hinging doors (62).

42. An improved damper assembly (50) adapted to and between a reciprocative device (10) and contingent object (62) such as a door closer device (10) and contingent door (62), said device (10) including a piston rod (16) which functions reciprocatively from within a piston body (12) having a biasing means (11), that, upon an applying an outward biasing force (11-A) causing extension of the rod (16-B) from within the body (12), said device (10) normally acting to control a reciprocative inward biasing force (11-B) responsive to the rod (16); comprising
a fixated bracket (50-B) housing an extensible bracket (50-A) controlling a counter biasing means (55) by use of an operator (54) that controls a counter outward biasing force (55-B) acting to accommodate the extended rod (16-B), and controls a counter inward biasing force (55-A) acting to return the device (10) and contingent door (62) to any normal position;
whereby the damper assembly (50) dampens, counters, protects, and compensates the door closer device (10) and contingent door (62) from damage due to excessive inward biasing force (11-B).
